(19) United States
(12) Patent Application Publication
(10) Pub. No.: US 2008/0172329 A1
(43) Pub. Date: Jul. 17, 2008

(54) CENTRALIZED AFFILIATED MARKETPLACES SYSTEMS AND METHODS

(76) Inventors: Matthew Kaufman, Redwood City, CA (US); John Dowd, San Jose, CA (US); Keith W. Teare, Palo Alto, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/623,002

(22) Filed: Jan. 12, 2007

(51) Int. Cl. G06Q 30/00; G06Q 10/00

(52) U.S. Cl. 705/40; 705/1

(57) ABSTRACT

A centralized marketplace for efficient and streamlined third party listings, including advertisements, to be placed within marketplaces. An automated backend coordinates the listing transactions, including the collection of fees, timings of display of listings, etc. Additionally, each marketplace may facilitate the placement of listings in affiliated marketplaces and similarly receive listings from affiliates for a fee or free.

### BACKGROUND

The patterns by which people receive information has transformed since the widespread use of the internet and during its life. Where people once consulted larger, general information sources, the trend today is often consultation of smaller, specialized information sources. Thus, the traffic to larger, general information sources is reduce today in favor of the smaller, specialized information sources. Naturally, the owners of the smaller, specialized marketplaces seek to capitalize on listings revenues, but often lack the personnel and other resources to efficiently display listings in their marketplaces.

During 1990's, the internet was dominated by large marketplaces. A marketplace is an online or offline venue that facilitates commerce and may range from large websites to small websites to offline print sources to individuals. Over the history of the internet, gradual shift from large, varied content marketplaces to smaller, more specialized marketplaces has occurred. This shift, naturally, has led to a revitalization of ways in which content owners, such as advertisers, generate revenue. Many larger marketplaces are loosing traffic to the more specialized marketplaces, which has caused content owners to reevaluate how and where advertising money is spent.

At the same time, however, the more specialized marketplaces tend to be smaller operations. Often, these marketplaces are created, maintained, and run by individuals or small groups of individuals. Although today the marketplaces generate increasing levels of traffic, by comparison to the traffic of the larger marketplaces the overall traffic is relatively small. Small marketplaces often struggle to attract larger advertising revenues that reflect their increased traffic because these smaller marketplaces do not have the personnel and resources to create and implement extensive advertising schemes. Thus, small marketplaces, although attracting traffic that has traditionally gone to larger marketplaces, are often unable to capture advertising revenues that should follow the increased traffic to their marketplaces.

Moreover, small marketplaces tend to be specialized and exist with other small marketplaces specializing in the same or similar subject matter. The competing marketplaces often exist in niches that appeal to various groups of traffic, and often include subsets of the same users. These small marketplaces form niche communities, and the owners of the marketplaces tend to be aware of, and in some cases collaborate with, the other similar marketplaces in the niche communities.

### SUMMARY

One embodiment, as described herein, provides a centralized marketplace for efficient and streamlined third party listings, including advertisements, to be placed within marketplaces. An automated backend coordinates the listing transactions, including the collection of fees, timings of display of listings, etc. Additionally, each marketplace may facilitate the placement of listings in affiliated marketplaces and similarly receive listings from affiliates for a fee or free.

According to a feature of the present disclosure, a method and system are disclosed comprising a first entity offering, via a site of a second entity, to generate a listing, the first entity generating and providing the listing to be displayed at the site of the second entity, the first entity distributing the listing to be displayed at a site of at least a third entity, in response to a user selecting the listing displayed at a site of a third entity, directing the user to the second entity for the listing.

Also according to a feature of the present disclosure is a machine-readable medium having stored thereon a set of instructions which when executed perform a method comprising: a first entity offering, via a site of a second entity, to generate a listing, the first entity generating and providing the listing to be displayed at the site of the second entity, the first entity distributing the listing to be displayed at a site of at least a third entity; and in response to a user selecting the listing displayed at a site of a third entity, directing the user to the second entity for the listing.

Finally, according to a feature of the present disclosure, a system is disclosed comprising a means for a first entity offering, via a site of a second entity, to generate a listing, a means for the first entity generating and providing the listing to be displayed at the site of the second entity, a means for the first entity distributing the listing to be displayed at a site of at least a third entity; and a means for directing the user to the second entity for the listing, in response to a user selecting the listing displayed at a site of a third entity.

### DRAWINGS

The above-mentioned features and objects of the present disclosure will become more apparent with reference to the following description taken in conjunction with the accompanying drawings wherein like reference numerals denote like elements and in which:

FIG. 1 is block diagram of an embodiment of a method of use of a centralized listing backend.

FIG. 2 is a block diagram of an embodiment of an affiliate system that may be used in conjunction with the centralized listing backend of the present disclosure.

FIG. 3 is a flow diagram of an embodiment of a method of submitting and viewing listings.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

In accordance with one embodiment, a centralized backend can utilize economics of scale to provide the resources for small marketplaces to earn revenue from listings, defined as content generated by parties independent of a particular marketplace with less expense and investment of energy. A marketplace is an online or offline venue that facilitates commerce and may range from large websites to small websites to offline print sources to individuals. Moreover, by using a centralized backend for listings, content owners, or people, groups of people, or organizations that submits content to a marketplace, may place listings at a single small marketplace and propagate the ad to other marketplaces. In addition, in one embodiment, smaller unique communities can be used as a platform to disseminate certain listings to a larger audience, which helps content providers more effectively place listings based on trends in the marketplace traffic.

Although one embodiment of the present disclosure is suited for smaller marketplaces, it is equally suited to be used with larger marketplaces to increase the visibility of their listings, in both online and traditional marketplaces, such as magazine and newspaper classifieds. Thus, the present disclosure provides a novel system and methods to centralize placement of listings. Content owners may therefore follow changes in marketplace traffic patterns, even where the traffic is diverted to small marketplaces where alone the level of traffic may not justify placement of marketplace content, which are listings submitted by the content owner.

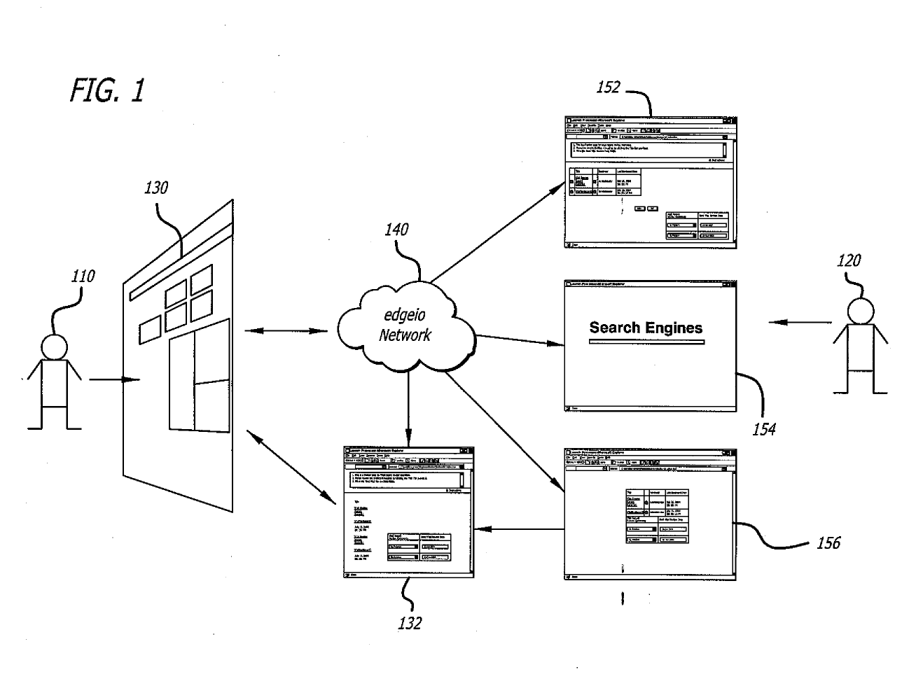

Turning to embodiments of FIG. 1, marketplaces 130 may be both online or offline, as would be known to artisans. Online marketplaces may be online classified systems of varying sizes, general or specific content websites, weblogs, commercial websites, and any other online resource where content owners are permitted to submit listings. Offline marketplaces, according to embodiments, may be traditional print media, such as classified advertisements, newspapers, and magazines. Marketplaces may also comprise radio and television advertising, according to embodiments, as well as individuals, such as a person's cell phone or computer system.

According to an embodiment shown in FIG. 1, a marketplace owner, comprising a person, a group of people, or an organization that sets the marketplace business terms or conducts the business of the marketplace. creates marketplace 130. The marketplace business terms are those terms and policies defining the display of listings on the marketplace. According to embodiments, marketplace 130 may be a website dedicated to publishing listings 132, or it may be a website dedicated to another purpose where advertising serves a role in conjunction with the other functions and features of given marketplace 130. For example, marketplace 130 may solely comprise a collection of classified listings 132 of boats. Similarly, marketplace 130 may comprise content related to boats including articles, discussion forums, and boating getaways, where advertising of boats is provided to the traffic visiting for the other features of marketplace 130.

Marketplace owners define their marketplace 130. According to embodiments, marketplace owners determine the type or classification of content permitted on their marketplace 130. The content and other materials found on marketplace 130, including the subject matter are therefore defined solely by the marketplace owner and the contributors to marketplace 130. Centralized listing backend 140 provides the engine for submission and display of listings 132 and may be used to coordinate the subject matter of listings 132 with the subject matter of marketplace 130 to provide consistency of subject matter.

According to embodiments, marketplace owner defines the behavior of centralized listing backend 140 as it applies to their marketplace 130. According to embodiments, marketplace owners may define the types or categories of goods or services that may be offered on marketplace 130 via listings 132. Thus, the marketplace owner can restrict the goods and services advertised to match the subject matter of marketplace 130, thereby increasing the value of advertising “real estate” on marketplace 130 by providing more productive marketplace content, which makes marketplace 130 more desirable to content owners 110 wishing to place listings 132 offering goods and services related to the subject matter of each marketplace 130.

Moreover, marketplace owners may define the layout and scheme of listings 132 posted to their marketplace 130. According to embodiments, marketplace owners may supply cascading stylesheets (CSS) or customized HTML, images, and colors to define to look and feel of listings 132, as known to artisans. Listings 132 are hosted by centralized listing backend 140, which applies a marketplace owner's look and feel of listing 132 according to embodiments. Thus, marketplace owners may duplicate the look and feel of marketplace 130 irrespective of where listing 132 is hosted. Marketplace owners may define fonts, colors, layouts, background images, and so forth of the listing.

According to embodiments, marketplace owners may define portions of each marketplace 130 webpage for display of listings 132 instead or in addition to a dedicated page (see FIG. 1). Using a JavaScript or Flash widget, for example, listings 132 may be displayed in predefined areas of marketplace 130, e.g., a banner or box of predetermined size, by retrieving from centralized listing backend 140 listings 132. Listings 132 retrieved will be defined by CSS or other similar methods of formatting the look and feel of the smaller listing real estate on marketplace 130.

According to similar embodiments, marketplace owners may host listings 132 by receiving syndication feeds of relevant listings 132. For example, listings 132 may be published and syndicated using an XML feed, such as a really simple syndication (RSS) feed, atom feed, or equivalents, and display listing 132 in marketplaces hosted by the marketplace owner. According to these embodiments, marketplace owners control all aspects of the look and feel of the marketplace. In one embodiment, these principles extend to offline marketplaces.

Marketplace owners may also define in centralized listing backend 140 administrative features of marketplace 130, according to embodiments. Marketplace owners may define fees to be paid by content owners 110 submitting listings 132. These fees may be flat fees, cost per click fees, or cost per action fees, according to embodiments. Artisans will recognize the various fee collection fees that may be used in conjunction with internet advertising and that may be implemented in conjunction with the present disclosure. Similarly, marketplace owners define the type of content, such as text, graphical marketplace content, classifieds, and so forth to be submitted, the length of time each listing 132 will persist in marketplace 130, the number of listings 132 that are permitted on marketplace 130 at any given time, the ways in which listings 132 expire from marketplace 130, and so forth. According to embodiments, the marketplace owner may also define whether marketplace 130 hosts an affiliate program and accepts listings 132 for other marketplaces 130. Additionally, according to embodiments, marketplace owner may select additional features such as textual decorations, that are permitted for listings 132, as well as premium content and placement of listings 132. The feature set available to marketplace owners vary with the implementation of centralized listing backend 140

Marketplace 130 is administered by centralized listing backend 140. A content owner 110 visits marketplace 130 to post listing 132. Using a javascript widget or flash widget, provided by centralized listing backend 140, for example, content owner 110 submits listing 132. The widget allows content owner 110 to submit listing 132 to centralized listing backend 140 directly from marketplace 130. According to embodiments, however, content owners 110 may visit centralized listing front-end 156 to submit listings 132, as well. From centralized listing front-end 156, content owner 110 may select one or more marketplaces 130 to submit listing 132.

Referring still to FIG. 1, centralized listing backend 140 may publish listings 132 to ancillary marketplaces 152, as well as make listings generally available to search engines 154. According to embodiments, listing 132 is posted to centralized listing backend 140. Centralized listing backend 140 may then make listings generally available to be searched via centralized listing front-end 156 or via search engines 154. According to embodiments, search engines 154 may be general search engines or specialized search engines. Moreover, search engines 154 may be search engines dedicated to a given subject matter, according to embodiments. Integration with search engines 154 and ancillary marketplaces and publishers 152 may be accomplished by providing XML feeds to the relevant marketplaces. XML feeds may comprise syndication feeds, such as RSS or Atom feeds, or may be proprietary, depending on the implementation of the feeds.

According to the embodiment shown in FIG. 1, listings 132 are hosted by centralized backend server 140. When consumer 120 investigates listing 132 link from marketplace 130, consumer 120 is directed to a listing 132 webpage hosted by centralized listing backend 140. Because marketplace owners will generally configure listing 132 to mirror the look and feel of marketplace 140, most users will be unaware when viewing listing 132 that they are no longer viewing content on marketplace 130, but rather content provided by centralized listing backend 140.

Similarly, consumers investigating links to listings 132 from ancillary marketplaces and publishers 152, search engines 154, or centralized listing front end 156 will be directed to listing 132. Listing 132 will be made up with data inputted by content owner 110 during submission of listing 132. All links in listing 132 webpages will direct consumer 120 to marketplace 130, according to embodiments. For example, a user may search centralized listing backend and select listing 132 from a set of results. Selecting listing 132 will take the user to listing 132 page hosted on centralized listing backend 146 which duplicates the look and feel of marketplace 140 where listing 132 was originally submitted. Conversely, where listing 132 is selected on different marketplace 140 where listing 132 was not originally submitted, listing 132 page displayed will mimic the look and feel of different marketplace 130, but with an annotation indicating that the item was published on marketplace 130 where it was originally published. The look and feel of each particular listing 132 varies case by case according to the various circumstances of the display of each listing 132.

Some marketplaces 130, according to embodiments, will display listing 132 as a portion of the content of marketplace 130, as previously described. According to embodiments, marketplaces 130 may be embedded with javascript widgets, for example, which pull listing 132 from centralized listing backend 140 and display listing 132 as an embedded portion of the overall content of marketplace 130 rather than linking consumer 120 to a standalone listing 132, as shown in FIG. 1. According to the exemplary embodiment, listing 132 may comprise a banner or other dedicated marketplace 130 real estate that displays listing 132 content hosted by centralized listing backend 140.

According to embodiments and as previously described, listings 132 may be hosted as part of the content of marketplace 130 by the marketplace owner. Marketplace owners may implement their own marketplace listings using XML feeds as previously described and as known by artisans.

As previously described, small, subject specific marketplaces tend to be familiar with other marketplaces offering similar content subject matter. Content owners that target the traffic of small, subject specific marketplaces stand to benefit from propagating a listing to a group of similarly situated marketplaces rather than visiting each to submit listing 132.

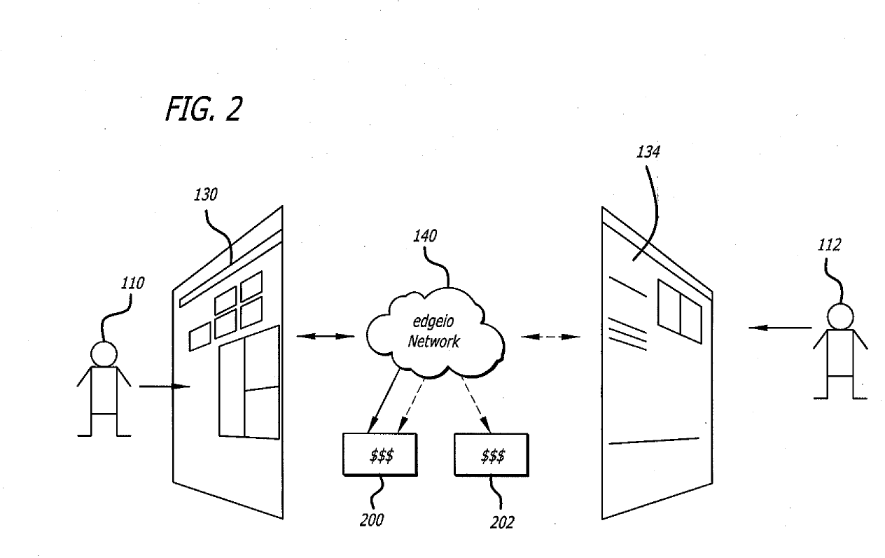

As shown in FIG. 2, content owners 110, 112 may propagate listings 132 to multiple marketplaces 130, 134 by visiting single marketplace 134 or a small subset of marketplaces 130, 134 where the content owners 110, 112 wish to post listings 132. Centralized listing backend 140 provides a platform for propagation of listing 132 from marketplace 134 to marketplace 130, as shown in an exemplary embodiment of FIG. 2. According to embodiments, marketplace owners receive a portion of revenues when listing 132 is propagated to their marketplace 130 from another marketplace 134.

According to an embodiment shown in FIG. 2, content owner 110 may submit listing 132 to a single marketplace 130. Marketplace owner, as part of the process of creating marketplace 130, will decide the payment structure for content owner's submission of listing 132. The payment structure, as previously described, may be any payment structure known to artisans for advertising goods and services online or offline, to which the principles of the present disclosure apply. For example, marketplace owner may charge content owner 110 based on a flat fee, cost per clicks (CPC), or cost per action (CPA), or real estate occupied by listing 132, according to embodiments.

For example, marketplace owner decides that marketplace content placed by content owners 110 on marketplace 130 will cost $200 for a week. Marketplace 130 is dedicated to sailboats, and contains articles relating to sailing, product reviews, America's Cup information, and other features of interest to sailors. Content owner 110 is a sailboat parts manufacturer and wishes to sell sailboat accessories. Content owner 110 chooses to place listing 132 to sell sailboat accessories on marketplace 130. Content owner 110 visits marketplace 130 to submit listing 132. Content owner 110 is directed to a form or other submission method, as would be known and understood by artisans.

Submission of listing 132 is made and ultimately submitted to centralized listing backend 140. Centralized listing backend 140 receives listing 132 and charges content owner 110 for placement of listing 132 and receives revenue 200, according to embodiments. Centralized listing backend 140, according to embodiments, retains a portion of revenue 200. Indeed, the services of centralized listing backend 140 may rely solely on retaining a portion of revenues 200 for listings 132 posted to marketplaces 130 according to embodiments.

Marketplace owner, according to the embodiment, receives revenue 200 collected by centralized listing backend 140 less any portion of revenue retained by centralized listing backend 140. Thus, marketplace owner may use centralized listing backend 140 to increase revenues by inducing placements of listings 132 without the need to maintain a marketplace backend to handle listings 132, including submission of the listings, display of the listings, timing of displays, expiry of listings, etc., and payment of revenue for each listing 132 submitted.

Referring still to embodiments shown in FIG. 2, content owner 110 may submit listings 132 to single marketplace 130, as shown. However, content owners 112 may also submit to a plurality of marketplaces 130, 134 in a single step by submitting listing 132 to single marketplace 134 and propagating listing 132 to other marketplaces, for example marketplace 130. For the purposes of the discussion below, marketplace 130 will be understood to represent at least one marketplace where listing 132 is propagated.

According to embodiments, content owner 112 may wish to submit listing 132 to a number of related marketplaces 130, 134. Centralized listing backend 140 provides a framework to submit listing 132 to single marketplace 134 and propagate listing 132 to a plurality of marketplaces, for example marketplace 130. Propagation can occur to a virtually unlimited number of marketplaces, provided the marketplaces are connected to centralized listing backend 140.

Centralized listing backend 140 handles propagation of listings 132, according to embodiments. Because centralized listing backend 140 hosts listing 132 (see e.g., FIG. 1), each marketplace 130, 134 where listing 132 is submitted or propagated by centralized listing backend 140 need only be configured with a javascript widget to have listings 132 displayed, according to embodiments. Where marketplace 130, 134 directly hosts listings 132, listings 132 submitted via other marketplaces may be received via XML feed, as previously described.

According to embodiments, revenues 202 are generated for the marketplace 134 where submission of listing 132 occurs as previously described. However, fee collection and distribution for marketplace 130 where listing was not originally submitted, but rather propagated, is modified, according to embodiments and as shown in FIG. 2 via dashed lines. Naturally, for content owner 112 to place listing 132 with both marketplace 134 and marketplace 130, content owner 112 must pay the fee to place listing 132 with each marketplace 130, 134. Because marketplace owners set their own revenue structures, content owners may be obligated to pay different fees or participate in different fee arrangements from marketplace to marketplace. A marketplace may charge a flat fee of $200 to place the listing for a week and another marketplace may charge $0.05 per click on listing 132, for example. Centralized listing backend 140 will collect fees from content owners 110, 112 based on the parameters defined by the marketplace owner for each marketplace 130, 134 that listing 132 is submitted.

Additionally, according to embodiments, marketplace owners may create an affiliate-type program to provide incentives to other marketplace owners to propagate listings 132 placed on their marketplaces 134 to marketplaces 130, so that marketplace 130 may also earn listing 132 submission fees. As referred to earlier, small, specialized content marketplaces tend to be aware of similar marketplaces. Moreover, content owners 112 are less inclined to place listings at single, small marketplaces with limited traffic, but more inclined to place listings with a number of similar marketplaces to increase the number of viewers of their listings 132. Thus, marketplace owners are in a unique position to point content owners 112 to others marketplaces 130 to increase the traffic potentially viewing their listings 132, thereby bring content owners 112 to their marketplace 134 by providing the incentive of connecting content owner 112 with similar marketplaces. Thus, content owners 112 may submit listing 132 at single marketplace 134 and choose to propagate listing 132 to similar marketplaces 130, without visiting each one or even being aware of the existence of the other marketplaces 130.

According to embodiments, content owner 112 submits listing 132 via marketplace 134. Marketplace owner may decide whether to participate in the affiliate-type program and the affiliates that will be offered to content owners 112 for listing 132 propagation during submission to marketplace 112, according to embodiments. Marketplace owners, according to further embodiments, decide the affiliate fee they will pay for listings propagated to their marketplace 130 as part of participation in the affiliate type program.

According to embodiments, during the listing submission process, content owner 112 may be presented with an option to propagate listing 132 to marketplaces 130 other than marketplace 134 on which content owner 112 is directly submitting listing 132. According to further embodiments, owner of marketplace 134 will have discretion as to which affiliate marketplaces 130 are presented to content owner 112. Consequently, if owner of marketplace 134 does not want to propagate listings 132 submitted via marketplace 134 to marketplaces 130 that do not play an affiliate fee or that marketplace owner does not want to drive content owners 112 to, the marketplace owner may omit them from the marketplaces to which content owner 112 may elect to propagate listing 132. Furthermore, owner of marketplace 134 may choose not to affiliate with any other marketplace; consequently, content owner 112 will be unable to propagate listing 132 to other marketplaces 130 from marketplace 134. Centralized listing backend 140 handles propagation and interaction with content owner 112 regarding propagation choices, according to embodiments.

As exemplified in FIG. 2, content owner 112 submits listing 132 to marketplace 134. During the submission process, content owner 112 is offered a choice of affiliates with which to propagate listing 132. According to embodiments, centralized listing backend 140 coordinates which marketplaces, for example marketplace 130, are offered to content owner 112. The offered choice of affiliates may detail various information about each affiliate including the price to list with the affiliate and other useful information, such as a summary of the subject matter offered at marketplace 130. In one embodiment, additional information is offered to a content owner 112 in conjunction with the decision as to which marketplaces to propagate listing 132.

Content owner 112 selects affiliates to which content owner 112 wishes to propagate listing 132. Content owner 112 may select, in addition to submission of listing 132 to marketplace 134, to have central listing backend 140 propagate listing to affiliated marketplaces 130. Content owner 112 would then pay revenue 202 and revenue 200, as shown by dashed lines in FIG. 2. However, marketplace 134 may receive an affiliate fee from affiliated marketplace 130 for referring listing 132 to affiliated marketplace 130.

Thus, for submitting listing 132 to marketplace 134, revenue 202 to marketplace 134 would comprise the listing fee revenue 202 less any portion of revenue 202 retained by centralized listing backend 140. For propagating listing 132 to affiliated marketplace 130, the owner of marketplace 134 may receives an affiliate fee, which may be designated by affiliated marketplace 130 or by marketplace 134, according to various embodiments and is added to revenue 202. Additionally, centralized listing backend 140 may retain a portion of revenue 200 to be paid to the owner of marketplace 130. Thus, revenue 200 paid to affiliated marketplace 130 owner will be gross revenue 200 less the affiliate fee paid to marketplace 134 owner and the portion retained by centralized listing backend 140.

For example, a sail manufacturer wishes to submit listing to a general boating marketplace for a flat fee of $200 for one week. However, the sail manufacturer also wishes to increase sales by submitting listings to other marketplaces dedicated to boating, particularly sailboating. During the submission process of the sail manufacturer's listing, sail manufacturer is presented with an option to propagate the listing to a dedicated sailboat marketplace for $225. The sailboat marketplace offers a $25 affiliate fee for referral of advertisers. The sail manufacturer selects both the general boating marketplace and the sailboat marketplace to submit and display a listing for custom-made sails.

Thus, because the custom-made sails listing is submitted to the general boating marketplace, the general boating marketplace earns a gross revenue of $200. Similarly, because the sail manufacturer elected to propagate the custom-made sales listing to the sailboating marketplace, the sailboating marketplace makes a gross revenue of $225. However, the centralized listing backend retains $50 of the gross revenue of each transaction. Additionally, the sailboating marketplace pays the general boating marketplace the $25 affiliate fee.

Consequently, for having the listing displayed for one week at both marketplaces, the general boating marketplace is paid $175 ($200 gross revenue−$50 centralized listing backend fee+$25 affiliate fee paid from the sailboating marketplace). The Sailboating marketplace is paid $150 ($225−$50 centralized listing backend fee−$25 affiliate fee paid to the general boating marketplace).

Centralized listing backend 140 automatically calculates the fees owed to each marketplace 130, 134, according to embodiments. Consequently, affiliate fees are not paid directly from marketplace 130 to marketplace 134, but rather centralized listing backend 140 calculates and adjusts revenues 200, 202 to reflect the amount owed to each marketplace 130, 134. Content owners 110, 112 tender payment in one of several ways, as well as revenues 200, 202 are dispersed to the marketplaces 130, 134 in one of several ways.

In one embodiment, centralized listing backend 140 screens listings and only permits propagation to marketplaces 130, 134 suitable for the listings. Thus, referring again to the boat example, a water ski company would be permitted to submit listing to the general boating marketplace. However, according to embodiments an option to propagate the listing to the sailboat marketplace would not be presented, as water skis are not used with sail boats. According to other embodiments, if listing 132 is unsuitable for a single marketplace that is offered to content owner 112 among a group of affiliates during the submission process of listing 132, content owner 112 may be precluded from propagating listing 132 altogether.

According to still similar embodiments, marketplace owner 130 precludes having listing 132 listed on their marketplace 130, regardless of the origin. Thus, marketplace owners 110 retain control over the content of their marketplaces 130, despite the ability of content owners 112 to propagate listing 132 to marketplace owner's 110 marketplace 130. Likewise according to other embodiments, marketplace owner 112 similarly precludes listing 132 that is submitted directly to their marketplace 134.

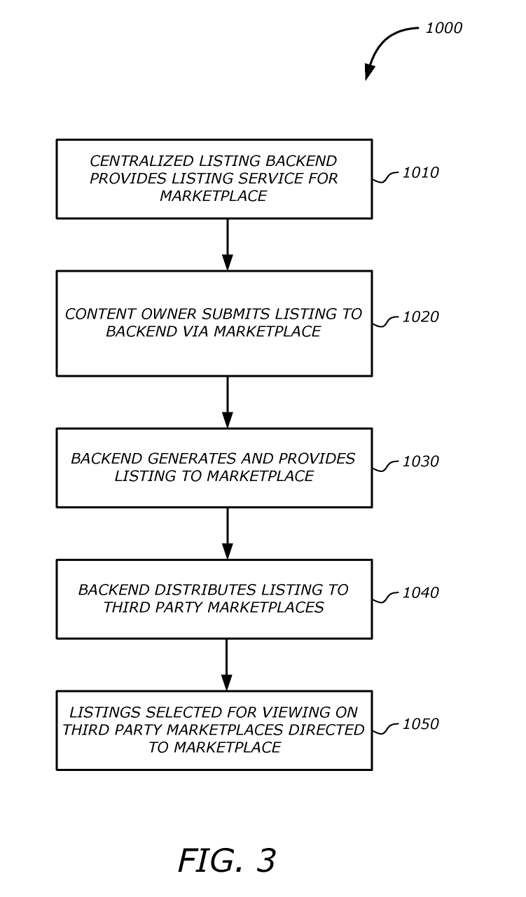

According to an embodiment shown in FIG. 3, a process 1000 is shown for submission and viewing of listings. According to an embodiment, a centralized listing backend provides a listing service for a marketplace 1010, as previously described. A content owner may then submit a listing to the centralized listing backend via the marketplace. Indeed, according to embodiments, content owner submits the listing directly to the centralized listing backend, even though content owner may be visiting the website of the marketplace. The centralized listing backend generates the listing content and provides the listing to the marketplace for viewing 1030. The centralized listing backend also distributes the listing to third party marketplaces 1040, for example a newspaper, affiliated website, or a search engine, according to embodiments. When a listing on a third party marketplace is selected, the user selecting the listing is referred back to the marketplace where it was originally submitted 1050, according to embodiments. According to similar embodiments, the user may view the listing at the third party marketplace, as described previously. Other variations are also described herein and are applicable as well.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

While the apparatus and method have been described in terms of what are presently considered to be the most practical and effective embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising
a first entity offering, via a site of a second entity, to generate a listing;
the first entity generating and providing the listing to be displayed at the site of the second entity;
the first entity distributing the listing to be displayed at a site of at least a third entity;
in response to a user selecting the listing displayed at a site of a third entity, directing the user to the second entity for the listing.

2. The method of claim 1, wherein the first entity comprises an application service provider.

3. The method of claim 1, wherein the listing includes an advertisement.

4. The method of claim 1, wherein the third entity receives no fee to display the listing.

5. The method of claim 1, wherein the first entity is to receive a portion of a fee paid for the listing.

6. The method of claim 1, further comprising the second entity defining one or more parameters of the listing to be generated.

7. The method of claim 1, wherein at least one of the site of the first entity and site of the second entity is offline.

8. The method of claim 1, wherein at least one of the site of the first entity and site of the second entity is a website.

9. The method of claim 2, further comprising the first entity billing a content owner for the generating and providing the listing, and providing at least a portion of the billing to the second entity.

10. The method of claim 9, further comprising the first entity providing at least a portion of the billing to the third entity, in response to a user selecting the listing on the site of the third entity.

11. The method of claim 10, further comprising billing the content owner in response to the listing being selected by a user.

12. (canceled)

13. The method of claim 9, further comprising billing the content owner of one of a cost per action or a cost per click.

14. The method of claim 1, wherein the distributing of the listing is performed without a request from the content owner or the second entity.

15. The method of claim 6, further comprising the first entity providing the second entity with an option to not distribute the listing to the site of the third entity.

16. The method of claim 1, wherein the first entity offering, via a site of a second entity, to generate an listing further comprises offering to the content owner to provide the listing on a site of the third entity for a fee charged by the third entity.

17. The method of claim 16, further comprising the third entity paying a fee to the second entity in response to the content owner selecting to have the listing provided on a site of the third entity for the fee charged by the third entity.

18. The method of claim 17, wherein at least one of the second entity and the third entity may refuse the listing provided by the content owner.

19. The method of claim 17, further comprising the first entity billing a content owner for the generating and providing the listing, and providing at least a portion of the billing to the second entity.

20. The method of claim 19, wherein a portion of the billing to be provided to the second entity includes the fee to be paid by the third entity to the second entity in response to the content owner selecting to have the listing provided on a site of the third entity.

21. The method of claim 20, wherein the first entity offering to provide the listing on the site of the third entity for the fee charged by the third entity, further comprises identifying the third entity based on a content of the listing.

22. The method of claim 21, wherein the third entity is pre-identified by the second entity to be offered to a content owner to have an listing provided at the site of the third entity in addition to the site of the second entity.

23. The method of claim 22, wherein the third entity is pre-identified by the second entity based on content of an listing.

24. The method of claim 1, wherein the listing distributed to be displayed at the site of the third entity is a sub-portion of the listing to be displayed at the site of the first entity.

25. A machine-readable medium having stored thereon a set of instructions which when executed perform a method comprising
a first entity offering, via a site of a second entity, to generate a listing;
the first entity generating and providing the listing to be displayed at the site of the second entity;
the first entity distributing the listing to be displayed at a site of at least a third entity; and
in response to a user selecting the listing displayed at a site of a third entity, directing the user to the second entity for the listing.

26. A system comprising
a means for a first entity offering, via a site of a second entity, to generate a listing;
a means for the first entity generating and providing the listing to be displayed at the site of the second entity;
a means for the first entity distributing the listing to be displayed at a site of at least a third entity; and
a means for directing the user to the second entity for the listing, in response to a user selecting the listing displayed at a site of a third entity.
